(19) United States
(12) Patent Application Publication
(10) Pub. No.: US 2016/0023567 A1
(43) Pub. Date: Jan. 28, 2016

(54) TEMPERATURE DEPENDENT ELECTROCHEMICAL BATTERY MODEL FOR VEHICLE CONTROL

(71) Applicant: Ford Global Technologies, LLC, Dearborn, MI (US)

(72) Inventor: Tae-Kyung LEE, Ann Arbor, MI (US)

(21) Appl. No.: 14/341,949

(22) Filed: Jul. 28, 2014

(51) Int. Cl. B60L 11/18; H01M 10/44; H01M 10/42; H02J 7/00; H01M 10/052

(52) U.S. Cl. CPC B60L 11/1861; H02J 7/0063; B60L 11/1877; H01M 10/052; H01M 10/425; H01M 10/443; H01M 2220/20; H01M 2010/4271

(57) ABSTRACT

A vehicle battery system includes a traction battery. The traction battery includes at least one cell having an anode, a cathode and an electrolyte therebetween defining a solid-electrolyte interface including an anode solid-electrolyte interface and a cathode solid-electrolyte interface. The system also includes at least one controller that operates the traction battery according to a battery operational variable that is based on a temperature dependent diffusion coefficient of the solid-electrolyte interface, a temperature dependent Ohmic resistance, a Li-ion concentration that is derived from a response to a current profile, and an operating battery current.

### TECHNICAL FIELD

This application is generally related to control of a vehicle battery system based on temperature dependent battery parameters and state variables of a reduced order model of a rechargeable vehicle battery.

### BACKGROUND

Hybrid-electric and pure electric vehicles rely on a traction battery to provide power for propulsion and may also provide power for some accessories. The traction battery typically includes a number of battery cells connected in various configurations. To ensure optimal operation of the vehicle, various properties of the traction battery may be monitored. One useful property is the battery state of charge (SOC) which indicates the amount of charge stored in the battery. The state of charge may be calculated for the traction battery as a whole and for each of the cells. The state of charge of the traction battery provides a useful indication of the charge remaining. The state of charge for each individual cell provides information that is useful for balancing the state of charge between the cells. In addition to the SOC, battery allowable charging and discharging power limits are valuable information to determine the range of battery operation and to prevent battery excessive operation. However, the estimation of the aforementioned battery responses is not easy to achieve using conventional methods, such as experiment based approaches or equivalent circuit model based approaches.

### SUMMARY

A vehicle includes a traction battery including cells each having an anode, a cathode and an electrolyte therebetween, and at least one controller programmed to operate the traction battery based on at least one temperature dependent electrode diffusion coefficient that increases as temperature increases, a temperature dependent Ohmic resistance that decreases as temperature increases, and an operating battery current.

A method of operating a traction battery having cells with electrodes includes outputting a temperature dependent Ohmic resistance based on a diffusion overpotential rate of change and an electrolyte electrical potential rate of change associated with a battery current, outputting a temperature dependent diffusion coefficient based on a frequency response, at frequencies less than a predetermined frequency, of the battery to a change in the battery current, and outputting a battery operational variable based on a battery model including the temperature dependent diffusion coefficient and temperature dependent Ohmic resistance. The method also includes operating the traction battery, by a controller, based on the battery operational variable, a battery temperature, the battery current and a battery current demand.

A vehicle battery system includes a traction battery including at least one cell having an anode, a cathode and an electrolyte therebetween defining a solid-electrolyte interface including an anode solid-electrolyte interface and a cathode solid-electrolyte interface. The system also includes at least one controller programmed to operate the traction battery according to a battery operational variable that is based on a temperature dependent diffusion coefficient of the solid-electrolyte interface, a temperature dependent Ohmic resistance, a Li-ion concentration that is derived from a response to a current profile, and an operating battery current.

### BRIEF DESCRIPTION OF THE DRAWINGS

FIG. 1 is a diagram of a hybrid vehicle illustrating typical drivetrain and energy storage components.

FIG. 2 is a diagram of a possible battery pack arrangement comprised of multiple cells, and monitored and controlled by a Battery Energy Control Module.

FIG. 3 is a diagram of an example battery cell equivalent circuit with one RC circuit.

FIG. 4 is an illustration of a cross section of a Metal-ion battery with porous electrodes.

FIG. 4A is an illustration of Li-ion concentration profiles inside representative particles in the negative electrode resulting from the Li-ion diffusion process during discharging.

FIG. 4B is an illustration of Li-ion concentration profiles inside representative particles in the positive electrode resulting from the Li-ion diffusion process during discharging.

FIG. 4C is an illustration of an active material solid particle and Li-ion transfer and diffusion processes.

FIG. 5 is a graph of the over-potential in relation to the cell thickness in response to a 10 second current impulse input.

FIG. 6 is a graph of the voltage drop in the electrolyte in relation to the cell thickness in response to a 10 second current impulse input.

FIG. 7 is a graph illustrating an open circuit potential curve at the positive electrode and negative electrode in relation to the normalized ion concentration for the anode and cathode of an electro-chemical battery.

FIG. 8 is a graph illustrating battery state of charge (SOC) and estimated Li-ion concentration profiles at representative electrode particles at the positive electrode and the negative electrode in relation to time.

FIG. 9 is an illustration and graph of the ion concentration of an even discretization and an uneven discretization along the radius of an active material particle.

FIG. 10 is a graph illustrating Li-ion concentration in relation to normalized radius of the electrode material with and without interpolation.

FIG. 11 is a graph illustrating the comparison of the battery state of charge errors from different methods in relation to time.

FIG. 12 is a graph illustrating the battery terminal voltage errors from different methods in relation to time.

FIG. 13 is a flowchart illustrating possible operations for battery power capability determination.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

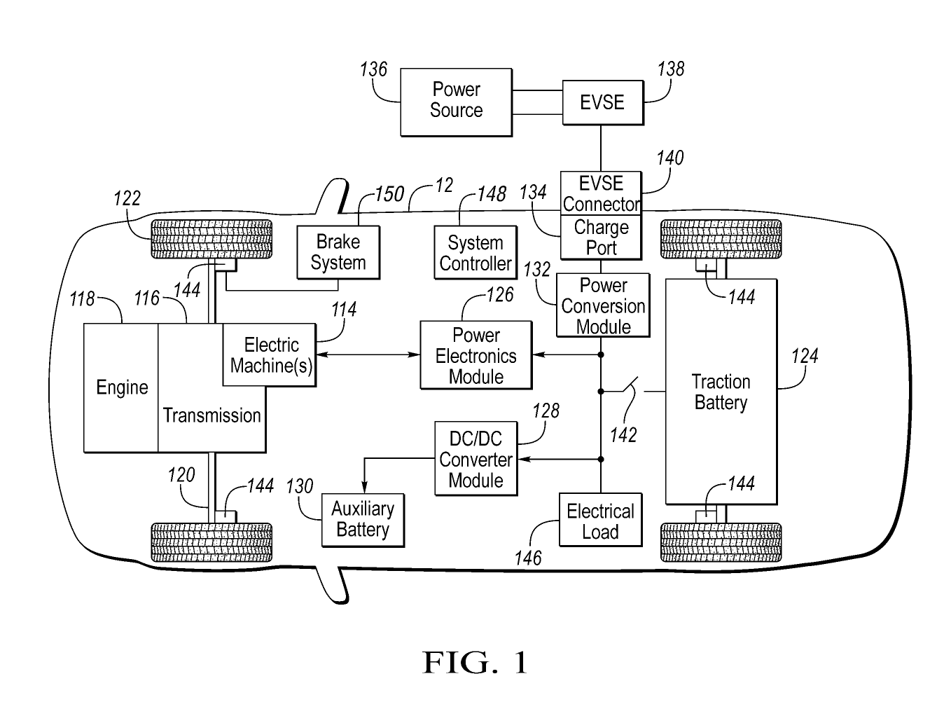

FIG. 1 depicts a typical plug-in hybrid-electric vehicle (HEV). A typical plug-in hybrid-electric vehicle 112 may comprise one or more electric machines 114 coupled to a hybrid transmission 116. The electric machines 114 may be capable of operating as a motor or a generator. In addition, the hybrid transmission 116 is coupled to an engine 118. The hybrid transmission 116 is also coupled to a drive shaft 120 that is coupled to the wheels 122. The electric machines 114 can provide propulsion and deceleration capability when the engine 118 is turned on or off. The electric machines 114 also act as generators and can provide fuel economy benefits by recovering energy that would normally be lost as heat in the friction braking system. The electric machines 114 may also reduce vehicle emissions by allowing the engine 118 to operate at more efficient conditions (engine speeds and loads) and allowing the hybrid-electric vehicle 112 to be operated in electric mode with the engine 118 off under certain conditions.

A traction battery or battery pack 124 stores energy that can be used by the electric machines 114. A vehicle battery pack 124 typically provides a high voltage DC output. The traction battery 124 is electrically connected to one or more power electronics modules. One or more contactors 142 may isolate the traction battery 124 from other components when opened and connect the traction battery 124 to other components when closed. The power electronics module 126 is also electrically connected to the electric machines 114 and provides the ability to bi-directionally transfer energy between the fraction battery 124 and the electric machines 114. For example, a typical traction battery 124 may provide a DC voltage while the electric machines 114 may use a three-phase AC current to function. The power electronics module 126 may convert the DC voltage to a three-phase AC current used by the electric machines 114. In a regenerative mode, the power electronics module 126 may convert the three-phase AC current from the electric machines 114 acting as generators to the DC voltage used by the fraction battery 124. The description herein is equally applicable to a pure electric vehicle. For a pure electric vehicle, the hybrid transmission 116 may be a gear box connected to an electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the fraction battery 124 to a low voltage DC supply that is compatible with other vehicle loads. Other high-voltage electrical loads 146, such as compressors and electric heaters, may be connected directly to the high-voltage without the use of a DC/DC converter module 128. The electrical loads 146 may have an associated controller that operates the electrical load 146 when appropriate. The low-voltage systems may be electrically connected to an auxiliary battery 130 (e.g., 12V battery).

The vehicle 112 may be an electric vehicle or a plug-in hybrid vehicle in which the traction battery 124 may be recharged by an external power source 136. The external power source 136 may be a connection to an electrical outlet. The external power source 136 may be electrically connected to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 12. The charge port 134 may be any type of port configured to transfer power from the EVSE 138 to the vehicle 112. The charge port 134 may be electrically connected to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically connected may transfer power using a wireless inductive coupling.

One or more wheel brakes 144 may be provided for decelerating the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components that work cooperatively to operate the wheel brakes 144. For simplicity, the figure depicts one connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 to decelerate or control the vehicle. The brake system 150 may respond to driver commands and may also operate autonomously to implement features such as stability control. The controller of the brake system 150 may implement a method of applying a requested brake force when requested by another controller or sub-function.

The various components discussed may have one or more associated controllers to control and monitor the operation of the components. The controllers may communicate via a serial bus (e.g., Controller Area Network (CAN)) or via discrete conductors. In addition, a system controller 148 may be present to coordinate the operation of the various components. A traction battery 124 may be constructed from a variety of chemical formulations. Typical battery pack chemistries may be lead acid, nickel-metal hydride (NIMH) or Lithium-Ion.

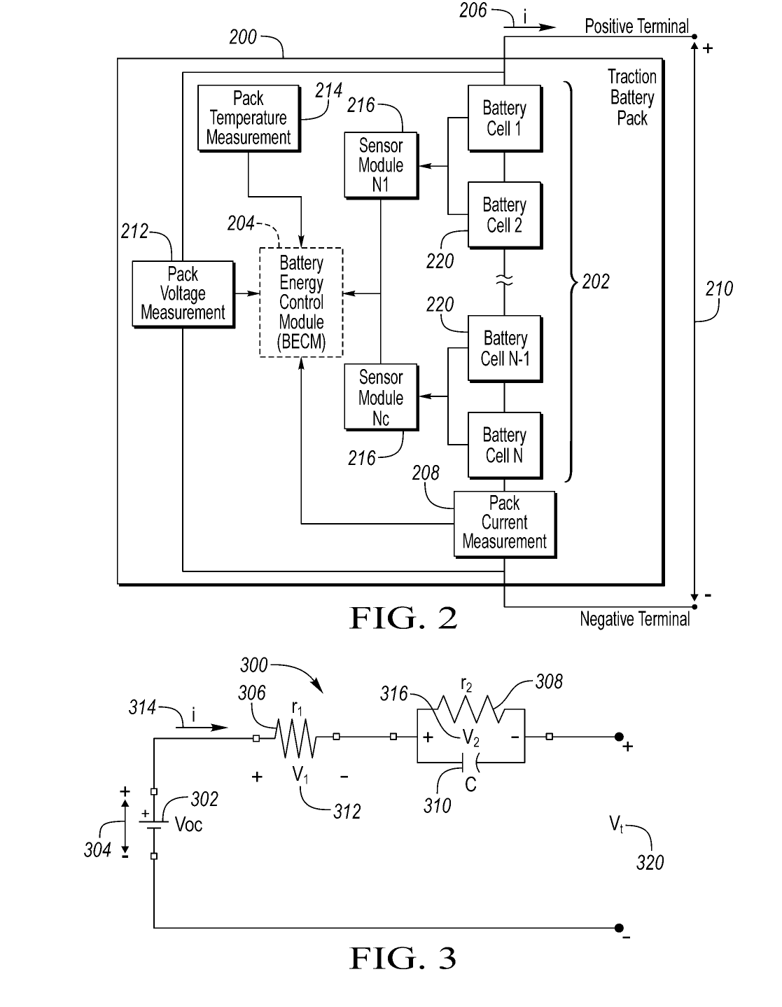

FIG. 2 shows a typical fraction battery pack 200 in a simple series configuration of N battery cells 202. Battery packs 200, may be composed of any number of individual battery cells connected in series or parallel or some combination thereof. A typical system may have a one or more controllers, such as a Battery Energy Control Module (BECM) 204 that monitors and controls the performance of the traction battery 200. The BECM 204 may monitor several battery pack level characteristics such as pack current 206 that may be monitored by a pack current measurement module 208, pack voltage 210 that may be monitored by a pack voltage measurement module 212 and pack temperature that may be monitored by a pack temperature measurement module 214. The BECM 204 may have non-volatile memory such that data may be retained when the BECM 204 is in an off condition. Retained data may be available upon the next ignition cycle. A battery management system may be comprised of the components other than the battery cells and may include the BECM 204, measurement sensors and modules (208, 212, 214), and sensor modules 216. The function of the battery management system may be to operate the traction battery in a safe and efficient manner.

In addition to the pack level characteristics, there may be battery cell 220 level characteristics that are measured and monitored. For example, the voltage, current, and temperature of each cell 220 may be measured. A system may use a sensor module 216 to measure the characteristics of individual battery cells 220. Depending on the capabilities, the sensor module 216 may measure the characteristics of one or multiple of the battery cells 220. The battery pack 200 may utilize up to N_{c} sensor modules 216 to measure the characteristics of each of the battery cells 220. Each sensor module 216 may transfer the measurements to the BECM 204 for further processing and coordination. The sensor module 216 may transfer signals in analog or digital form to the BECM 204. In some embodiments, the functionality of the sensor module 216 may be incorporated internally to the BECM 204. That is, the sensor module 216 hardware may be integrated as part of the circuitry in the BECM 204 wherein the BECM 204 may handle the processing of raw signals.

The battery cell 200 and pack voltages 210 may be measured using a circuit in the pack voltage measurement module 212. The voltage sensor circuit within the sensor module 216 and pack voltage measurement circuitry 212 may contain various electrical components to scale and sample the voltage signal. The measurement signals may be routed to inputs of an analog-to-digital (A/D) converter within the sensor module 216, the sensor module 216 and BECM 204 for conversion to a digital value. These components may become shorted or opened causing the voltage to be measured improperly. Additionally, these problems may occur intermittently over time and appear in the measured voltage data. The sensor module 216, pack voltage sensor 212 and BECM 204 may contain circuitry to ascertain the status of the voltage measurement components. In addition, a controller within the sensor module 216 or the BECM 204 may perform signal boundary checks based on expected signal operating levels.

A battery cell may be modeled in a variety of ways. For example, a battery cell may be modeled as an equivalent circuit. FIG. 3 shows one possible battery cell equivalent circuit model (ECM) 300, called as a simplified Randles circuit model. A battery cell may be modeled as a voltage source 302 having an open circuit voltage (V_{oc}) 304 having an associated impedance. The impedance may be comprised of one or more resistances (306 and 308) and a capacitance 310. The V_{oc} 304 represents the open-circuit voltage (OCV) of the battery expressed as a function of a battery state of charge (SOC) and temperature. The model may include an internal resistance, r₁ 306, a charge transfer resistance, r₂ 308, and a double layer capacitance, C 310. The voltage V₁ 312 is the voltage drop across the internal resistance 306 due to current 314 flowing from the voltage source 302. The voltage V₂ 316 is the voltage drop across the parallel combination of r₂ 308 and C 310 due to current 314 flowing through the parallel combination. The voltage Vₜ 320 is the voltage across the terminals of the battery (terminal voltage). The parameter values, r₁, r₂, and C may be known or unknown. The value of the parameters may depend on the cell design and the battery chemistry.

Because of the battery cell impedance, the terminal voltage, Vₜ 320, may not be the same as the open-circuit voltage, V_{oc} 304. As typically only the terminal voltage 320 of the battery cell is accessible for measurement, the open-circuit voltage, V_{oc} 304, may not be readily measurable. When no current 314 is flowing for a sufficiently long period of time, the terminal voltage 320 may be the same as the open-circuit voltage 304, however typically a sufficiently long period of time may be needed to allow the internal dynamics of the battery to reach a steady state. Often, current 314 is flowing in which V_{oc} 304 may not be readily measurable and the value inferred based on the equivalent circuit model 300 may have errors by not capture both fast and slow dynamic properties of the battery. The dynamic properties or dynamics are characterized by a frequency response, which is the quantitative measure of the output spectrum of a system or device (battery, cell, electrode or sub-component) in response to a stimulus (change in current, current profile, or other historical data on battery current). The frequency response may be decomposed into frequency components such as fast responses to a given input and slow responses to the given input. The relative term fast responses and slow responses can be used to describe response times less than a predetermined time (fast) or greater than a predetermined time (slow). To improve battery performance, a model that captures both fast and slow battery cell dynamics is needed. Current battery cell models are complex and are not practical for modern electronic control systems. Here a reduced order battery cell model that is reduced in complexity such that it may be executed on a microcontroller, microprocessor, ASIC, or other control system and captures both fast and slow dynamics of the battery cell is disclosed to increase the performance of the battery system.

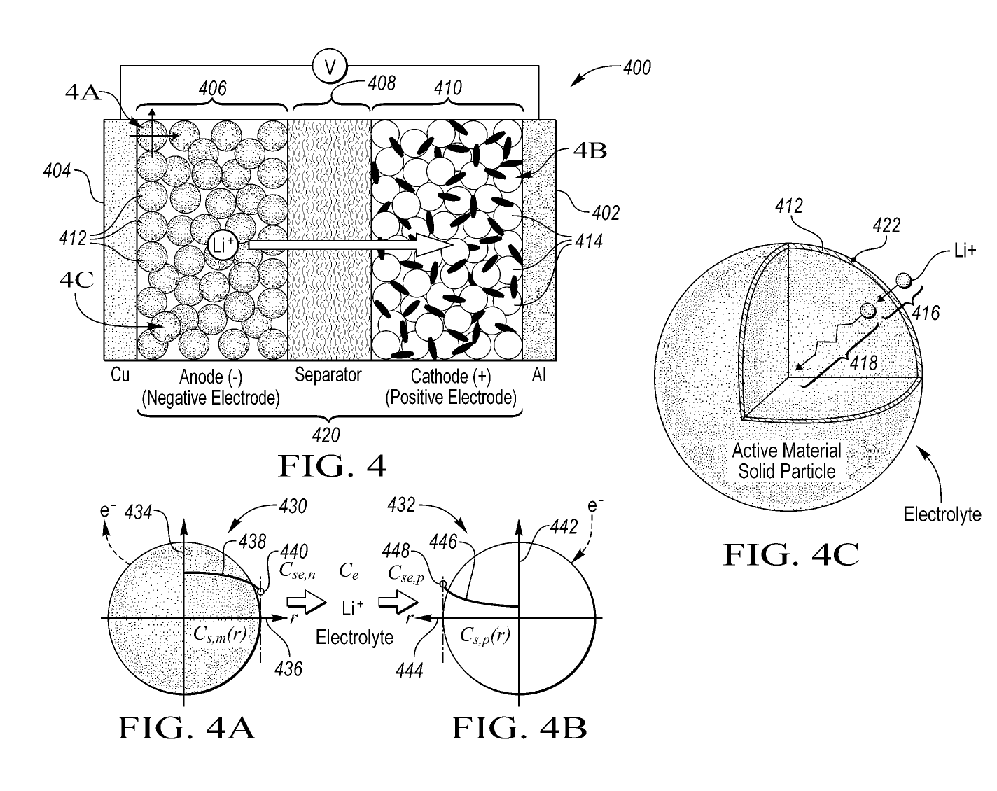

FIG. 4 is an illustration of the cross section of the laminated structure of a Metal-ion battery cell 400 or cell. This Metal-ion battery cell 400 may be a Li-ion battery cell. The laminated structure may be configured as a prismatic cell, a cylindrical cell or other cell structure with respect to various packaging methods. The cell geometry or physical structure may be different (e.g. cylindrical, rectangular, etc.), but the basic structure of the cell is the same. Generally, the Metal-ion cell 400, for example a Li-ion battery, includes a positive current collector 402 which is typically aluminum, but may be another suitable material or alloy, a negative current collector 404 which is typically copper, but may be another suitable material or alloy, a negative electrode 406 which is typically carbon, graphite or graphene, but may be another suitable material, a separator 408, and a positive electrode 410 which is typically a metal oxide (e.g. lithium cobalt oxide (LiCoO₂), Lithium iron phosphate (LiFePO₄), lithium manganese oxide (LMnO₂)), but may be another suitable material. Each electrode (406, 410) may have a porous structure increasing the surface area of each electrode, in which Metal-ions (e.g. Li-ions) travel across the electrode though the electrolyte and diffuse into/out of electrode solid particles (412, 414).

There are multiple ranges of time scales existent in electrochemical dynamic responses of a Metal-ion battery 400. For example with a Li-ion battery, factors which impact the dynamics include but are not limited to the electrochemical reaction in active solid particles 412 in the electrodes and the mass transport of Lithium-ion across the electrodes 416. When considering these aspects, the basic reaction in the electrodes may be expressed as

Θ+Li++e−⇄Θ−Li (1)

In which Θ is the available site for intercalation, Li⁺ is the Li-ion, e⁻ is the electron, and Θ−Li is the intercalated Lithium in the solid solution.

This fundamental reaction expressed by equation (1) is governed by multiple time scale processes. This is shown in FIG. 4C, in which the categories of the processes include charge transfer 416, diffusion 418, and polarization 420. These terms differ from the definitions used by the electrochemical society to facilitate a reduced-order electrochemical battery model derivation. Here, the charge transfer process 416 represents the Metal-ion exchange behavior across the solid-electrolyte interface (SEI) 422 at each active solid particle (412, 414). The charge transfer process is fast (e.g. less than 100 milliseconds) under most cases and directly affected by the reaction rate at each electrode (406 & 410). There are multiple frequency components for the charge transfer, the charge transfer consists of both fast and slow dynamics, or in other words the charge transfer has frequency components less and greater than a predetermined frequency. The diffusion process 418 represents the Metal-ion transfer from the surface to the center of the solid particle or vice versa. The diffusion process is slow (e.g. greater than 1 second) and is determined by the size and material of active solid particle (412, 414), and the Metal-ion intercalation level. There are multiple frequency components for the diffusion process, the diffusion process consists of both fast and slow dynamics, or in other words the diffusion process has frequency components less and greater than a predetermined frequency. The polarization 420 process includes all other conditions having inhomogeneous Metal-ion concentrations in the electrolyte or electrode in space. The polarization 420 caused by the charge transfer 416 and the diffusion 418 is not included in this categorization. There are multiple frequency components for the polarization, the polarization consists of both fast and slow dynamics, or in other words the polarization has frequency components less and greater than a predetermined frequency.

The anode 406 and cathode 410 may be modeled as a spherical material (i.e. spherical electrode material model) as illustrated by the anode spherical material 430 and the cathode spherical material 432. However other model structures may be used. The anode spherical material 430 has a metal-ion concentration 434 which is shown in relation to the radius of the sphere 436. The concentration of the Metal-ion 438 changes as a function of the radius 436 with a metal-ion concentration at the surface to electrolyte interface of 440. Similarly, the cathode spherical material 432 has a metal-ion concentration 442 which is shown in relation to the radius of the sphere 444. The concentration of the Metal-ion 446 changes as a function of the radius 444 with a metal-ion concentration at the surface to electrolyte interface of 448.

The full-order electrochemical model of a Metal-ion battery 400 is the basis of a reduced-order electrochemical model. The full-order electrochemical model resolves Metal-ion concentration through the electrode thickness (406 & 410) and assumes the Metal-ion concentration is homogeneous throughout the other coordinates. This model accurately captures the key electrochemical dynamics. The model describes the electric potential changes and the ionic mass transfer in the electrode and the electrolyte by four partial differential equations non-linearly coupled through the Butler-Volmer current density equation.

The model equations include Ohm's law for the electronically conducting solid phase which is expressed by equation (2),

\vec{∇}ₓσ^{eff}\vec{∇}ₓφₛ=j^{Li}, (2)

Ohm's law for the ion-conducting liquid phase is expressed by equation (3),

\vec{∇}ₓκ^{eff}\vec{∇}ₓφₑ+\vec{∇}ₓκ_{D}^{eff}\vec{∇}ₓ ln cₑ=−j^{Li}, (3)

Fick's law of diffusion is expressed by equation (4),

$$\frac{\partial {c}_{s}}{\partial t} = {\vec{∇}}_{r} ( {D}_{s} {\vec{∇}}_{r} {c}_{s} ) , \qquad ( 4 )$$

Material balance in the electrolyte is expressed by equation (5),

$$\frac{\partial {ɛ}_{e} {c}_{e}}{\partial t} = {\vec{∇}}_{x} ( {D}_{e}^{eff} {\vec{∇}}_{x} {c}_{e} ) + \frac{1 - {t}^{0}}{F} {j}^{Li} , \qquad ( 5 )$$

Butler-Volmer current density is expressed by equation (6),

$${j}^{Li} = {a}_{s} {j}_{0} [ exp ( \frac{{α}_{a} F}{RT} η ) - exp ( - \frac{{α}_{c} F}{RT} η ) ] , \qquad ( 6 )$$

in which φ is the electric potential, c is the Metal-ion concentration, subscript s and e represent the active electrode solid particle and the electrolyte respectively, σ^{eff} is the effective electrical conductivity of the electrode, κ^{eff} is the effective electrical conductivity of the electrolyte, κ_{D}^{eff} is the liquid junction potential term, Dₛ is the diffusion coefficient of Metal-ion in the electrode, Dₑ^{eff} is the effective diffusion coefficient of Metal-ion in the electrolyte, t⁰ is the transference number, F is the Faraday constant, αₐ is the transfer coefficient for anodic reaction, α_{c} is the transfer coefficient for cathodic reaction, R is the gas constant, T is the temperature, η=φₛ−φₑ−U(cₛₑ) is the over potential at the solid-electrolyte interface at an active solid particle, and j₀=k(cₑ)^{α}^{ₐ}(c_{s,max}−cₛₑ)^{α}^{ₐ}(cₛₑ)^{α}^{_{c}}.

Fast and slow dynamic responses were evaluated and validated by comparing the dynamic responses to test data under the same test conditions, for example, a dynamic response under a ten second discharging pulse are computed using a full-order battery model to investigate the battery dynamic responses.

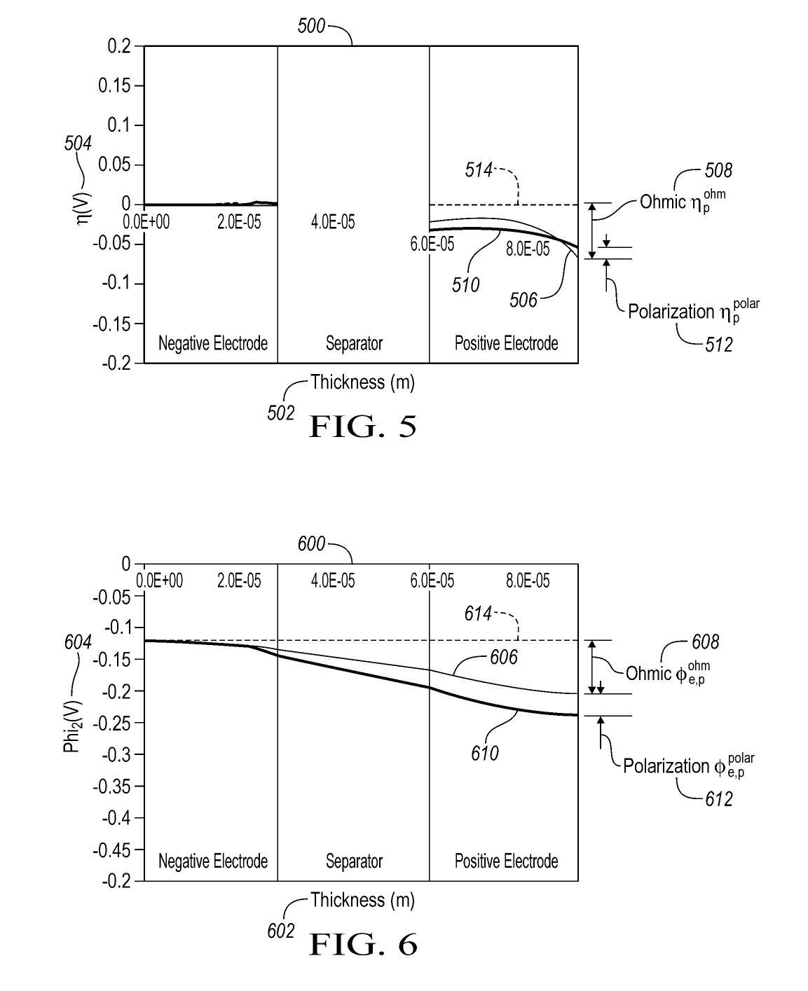

The analysis of the dynamic responses includes the diffusion overpotential difference and the electric potential difference of the electrolyte. FIG. 5 is a graphical representation of the change in overpotential with respect to distance on an axis, in this example, the radius of the spherical battery model. Here, the overpotential difference between the current collectors 500 is expressed as

j₀=k(Cₑ)^{α}^{ₐ}(C_{s,max}−Cₛₑ)^{α}^{ₐ}(Cₛₑ)^{α}^{_{c}}.

The x axis represents the electrode thickness 502, and the y axis represents the overpotential 504. At the positive current collector when a 10 sec current pulse is applied, the instantaneous voltage drop is observed. At zero second 506, the voltage is influenced by the Ohmic term 508. As time increases, as shown at 5 seconds 510, the voltage is additional influenced by the polarization term 512 wherein the voltage is influenced by both the Ohmic and the polarization term, until the voltage influence reaches steady state as shown at time 100 seconds 514. The voltage drop at the positive current collector is slightly changing while input current is applied. Two dominant time scales, instantaneous and medium-to-slow, are observed in the over potential difference responses.

FIG. 6 is a graphical representation of the change in electrolyte electrical potential (electrical potential) with respect to distance on an axis, in this example, the radius of the spherical battery model. The electrolyte electrical potential difference of the electrolyte between the current collectors 600, expressed as φₑ|_{x=L}−φₑ|ₓ₌₀,

is shown in FIG. 6. The x axis represents the electrode thickness 602, and they axis represents the electrical potential 604. There is an instantaneous voltage drop at zero second 606. The instantaneous voltage drop is mainly governed by the electrical conductivity of the electrolyte 608. The voltage change after the initial drop, as shown at 5 seconds 610, is governed by Metal-ion transport across the electrodes 612. The steady state potential is shown at 100 seconds 614. The electrochemical dynamics, such as local open circuit potential, over potential and electrolyte potential, include both instantaneous-to-fast dynamics and slow-to-medium dynamics.

The use of the full-order dynamics in a real-time control system is computationally difficult and expensive using modern microprocessors and microcontrollers. To reduce complexity and maintain accuracy, a reduced-order electrochemical battery model should maintain data relevant to physical information throughout the model reduction procedure. A reduced-order model for battery controls in electrified vehicles should be valid under a wide range of battery operation to maintain operational accuracy. The model structure may be manipulated to a state-space form for control design implementation. Although significant research has been conducted to develop reduced-order electrochemical battery models, an accurate model has previously not been available for use in a vehicle control system. For example, single particle models typically are only valid under low current operating conditions due to the assumption of uniform Metal-ion concentration along the electrode thickness. Other approaches (relying on model coordinate transform to predict terminal voltage responses) lose physically relevant information of the electrochemical process.

A new approach is disclosed to overcome aforementioned limitations of previous approaches. This newly disclosed model reduction procedure is designed: (1) to capture broad time scale responses of the electrochemical process; (2) to maintain physically relevant state variables; and (3) to be formulated in a state-space form.

The reduction procedure starts from the categorization of electrochemical dynamic responses in a cell. The electrochemical dynamics are divided into “Ohmic” or instantaneous dynamics 506 and 606, and “Polarization” or slow-to-medium dynamics 510 and 610. The battery terminal voltage may be expressed by equation (7),

V=φₛ|_{x=L}−φₛ|ₓ₌₀, (7)

the over potential at each electrode may be expressed by equation (8),

ηᵢ=φ_{s,i}−φ_{e,i}−Uᵢ(θᵢ), (8)

in which Uᵢ(θᵢ) is the open-circuit potential of i^{th} electrode as a function of a normalized metal-ion concentration. From eqns. (7) and (8), the terminal voltage may be expressed by equation (9),

$$\begin{matrix}V = {( {U}_{p} ( {θ}_{p} ) {{\vert}_{x = L} + {φ}_{e} \vert}_{x = L} + {η}_{p} \vert}_{x = L} ) - \\ {( {U}_{n} ( {θ}_{n} ) {{\vert}_{x = 0} + {φ}_{e} \vert}_{x = 0} + {η}_{n} \vert}_{x = 0} ) \\ {= {U}_{p} ( {θ}_{p} ) {{\vert}_{x = L} - {U}_{n} ( {θ}_{n} ) \vert}_{x = 0} + {η}_{p} \vert}_{x = L} - \\ { {η}_{n} {{\vert}_{x = 0} + {φ}_{e} \vert}_{x = L} - {φ}_{e} \vert}_{x = 0} .\end{matrix} \qquad ( 9 )$$

The battery terminal voltage in eqn. (9) includes the open-circuit potential difference between the current collectors which may be expressed as (Uₚ(θₚ)|_{x=L}−Uₙ(θₙ)|ₓ₌₀),

the over potential difference between the current collectors which may be expressed as (nₚ|_{x=L}−nₙ|ₓ₌₀),
and the electrolyte electrical potential difference between the current collectors which may be expressed as (φₑ|_{x=L}−φₑ|ₓ₌₀).

The terminal voltage may be reduced to equation (10),

$$\begin{matrix}{{V = {U}_{p} ( {θ}_{p} ) \vert}_{x = L} - {U}_{n} ( {θ}_{n} ) \vert}_{x = 0} + \\ {{{{ {η}_{p} \vert}_{x = L} - {η}_{n} \vert}_{x = 0} + {φ}_{e} \vert}_{x = L} - {φ}_{e} \vert}_{x = 0} \\ {{= {U}_{p} ( {θ}_{p} ) \vert}_{x = L} - {U}_{n} ( {θ}_{n} ) \vert}_{x = 0} + Δ η + Δ {φ}_{e} .\end{matrix} \qquad ( 10 )$$

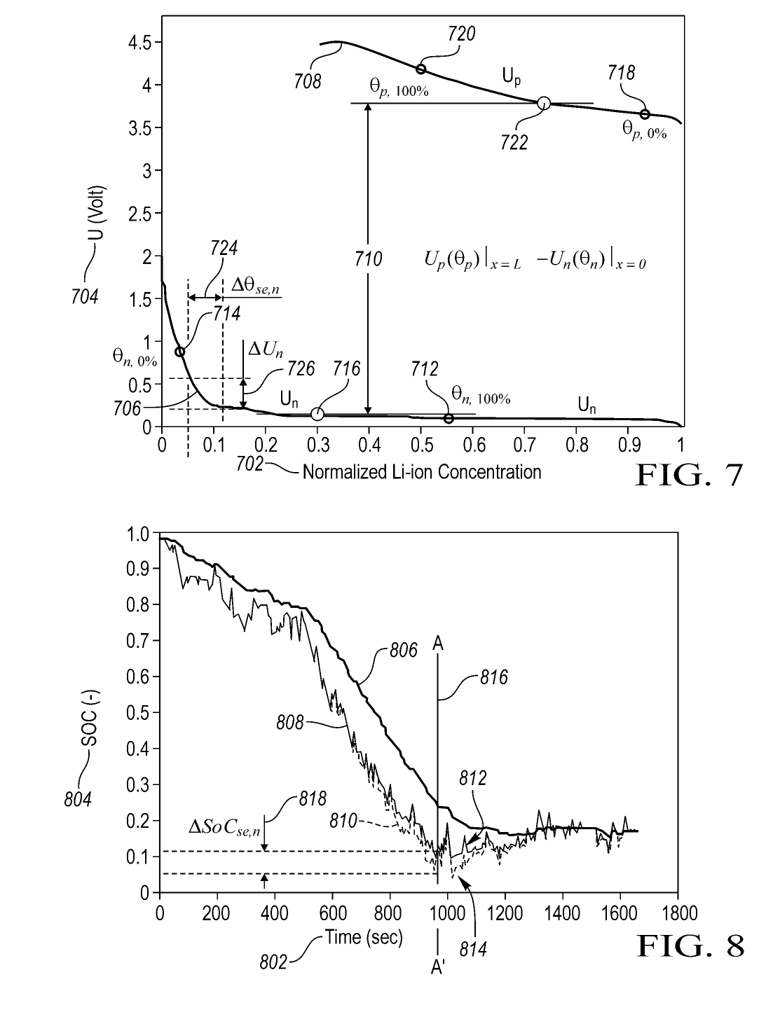

FIG. 7 illustrates a graphical representation of the surface potentials of the active solid particles at the current collectors 700. The x axis represents the normalized metal-ion concentration 702, and the y axis represents the electrical potential 704. The surface potential of the anode 706 may be expressed by uₙ(θₙ)|ₓ₌₀

and the surface potential of the cathode 708 may be expressed by Uₚ(θₚ)|_{x=L}.
The x axis represents the normalized Metal-ion concentration 706, and the y axis represents the surface potential in volts 708. The difference of surface potential 710 may be expressed by Uₚ(θₚ)|_{x=L}−Uₙ(θₙ)|ₓ₌₀
in which the normalized Metal-ion concentration in each electrode is expressed as θ_{s,p}=c_{s,p}^{eff}/c_{s,p,max} and θ_{s,n}=c_{s,n}^{eff}/c_{s,n,max} respectively. The normalized metal-ion concentration of the anode when the battery state of charge is at 100% is shown at point 712 and the normalized metal-ion concentration of the anode when the battery state of charge is at 0% is shown at point 714, with an operating point at a moment in time being shown as 716, as an example. Similarly, the normalized metal-ion concentration of the cathode when the battery state of charge is at 100% is shown at point 720 and the normalized metal-ion concentration of the cathode when the battery state of charge is at 0% is shown at point 718, with an operating point at the moment in time being shown as 722, as an example. Viewing a change of concentration along the anode 706 and cathode 708, as the SOC increases, the anode operating point at a moment in time 716 moves from left to right, and the cathode operating point at the moment in time 722 moves from right to left. Due to many factors including chemistry and composition, the current operating point of the cathode 722 can be expressed as a function of the current operating point of the normalized anode concentration 716 and battery SOC. Similarly, the current operating point of the anode 716 can be expressed as a function of the current operating point of the normalized cathode concentration 722 and battery SOC.

The normalized Metal-ion concentration θ is mainly governed by the diffusion dynamics and slow dynamics across the electrodes. Resolving Δη and Δφ from equation (10) into “Ohmic” and “Polarization” terms is expressed as by equations (11) and (12),

Δη=Δη^{Ohm}+Δη^{polar}, (11)

Δφₑ=Δφₑ^{Ohm}+Δφₑ^{polar}. (12)

The “Ohmic” terms include instantaneous and fast dynamics, the “Polarization” terms include medium to slow dynamics. The terminal voltage of equation (10) may then be expressed as equation (13),

V=Uₚ(θₚ)|_{x=L}−Uₙ(θₙ)|ₓ₌₀+Δn^{polar}+Δφₑ^{polar}+Δn^{Ohm}+Δφₑ^{Ohm}. (13)

Equation (13) represents the battery terminal voltage response without loss of any frequency response component. The first four components of equation (13) are related to the slow-to-medium dynamics, including diffusion and polarization. The slow-to-medium dynamics are represented as “augmented diffusion term”. The last two components of equation (13) represent the instantaneous and fast dynamics. The instantaneous and fast dynamics are represented as “Ohmic term”.

The augmented diffusion term may be modeled using a diffusion equation to maintain physically relevant state variables.

$$\frac{\partial {c}_{s}^{eff}}{\partial t} = {\vec{∇}}_{r} ( {D}_{s}^{eff} {\vec{∇}}_{r} {c}_{s}^{eff} ) , \qquad ( 14 )$$

in which cₛ^{eff} is the effective Metal-ion concentration accounting for all slow-to-medium dynamics terms, and Dₛ^{eff} is the effective diffusion coefficient accounting for all slow-to-medium dynamics terms. The boundary conditions for equation (14) are determined as

$$\begin{matrix}{\frac{\partial {c}_{s}^{eff}}{\partial r} \vert}_{r = 0} = 0 , & ( 15 a ) \\ {\frac{\partial {c}_{s}^{eff}}{\partial r} \vert}_{r = {R}_{s}} = - \frac{I}{δ {AFa}_{s} {D}_{s}^{eff}} , & ( 15 b )\end{matrix}$$

in which A is the electrode surface area, δ is the electrode thickness, Rₛ is the active solid particle radius, and

$${a}_{s} = \frac{3 {ɛ}_{s}}{{R}_{s}} ,$$

in which εₛ is the porosity of the electrode. The Ohmic term is modeled as

−R₀^{eff}I, (16)

in which R₀^{eff} is the effective Ohmic resistance accounting for all instantaneous and fast dynamics terms, and I is the battery current. R₀^{eff} is obtained by deriving the partial differential equation (13) with respect to the battery current I and expressed as

$${R}_{0}^{eff} = - ( \frac{\partial Δ {η}^{Ohm}}{\partial I} + \frac{\partial Δ {φ}_{e}^{Ohm}}{\partial I} ) . \qquad ( 17 )$$

The effective Ohmic resistance can be modeled based on equation (17), or can be determined from test data.

The terminal voltage may then be expressed as

V=Uₚ(θ_{se,p})−Uₙ(θ_{se,n})−R₀^{eff}I, (18)

in which the normalized Metal-ion concentration at the solid/electrolyte interface of the cathode is θ_{se,p}=c_{se,p}^{eff}/c_{s,p,max}, the normalized Metal-ion concentration at the solid/electrolyte interface of the anode is θ_{se,n}=c_{se,n}^{eff}/c_{s,n,max}, c_{s,p,max} is the maximum Metal-ion concentration at the positive electrode, c_{s,n,max} is the maximum Metal-ion concentration at the negative electrode, and cₛₑ^{eff} is the effective Metal-ion concentration at the solid-electrolyte interface.

Equation (18) may be expressed as three model parameters, the anode effective diffusion coefficients (D_{s,n}^{eff}), the cathode effective diffusion coefficients (D_{s,p}^{eff}), effective internal resistance of both the anode and cathode (R₀^{eff}), and one state vector, the effective Metal-ion concentration (cₛ^{eff}). The state vector effective Metal-ion concentration (cₛ^{eff}) includes the anode state vector effective Metal-ion concentration (cₛ^{eff}), which may be governed by the anode effective diffusion coefficients (Dₛ^{eff}), and cathode state vector effective Metal-ion concentration (c_{s,p}^{eff}), which may be governed by the cathode effective diffusion coefficients (D_{s,p}^{eff}) based on the application of equation (14). The parameters may be expressed as functions of, but not limited to, temperature, SOC, battery life, battery health and number of charge cycles applied. The parameters (D_{s,n}^{eff}, D_{s,p}^{eff}, R₀^{eff}) may be determined by modeling, experimentation, calibration or other means. The complexity of the model calibration process is reduced compared to ECMs with the same level of prediction accuracy. FIG. 3 is a possible ECM for modeling the electrical properties of a battery cell. As more RC elements are added to an ECM, more model parameters and state variables are required. For example, an ECM with three RC components requires seven model parameters.

Referring back to FIG. 7, the normalized Metal-ion concentration at the solid/electrolyte interface of the anode θ_{se,n} may be expressed as a function of the normalized Metal-ion concentration at the solid/electrolyte interface of the cathode θ_{se,p} and the battery state of charge SOCₐᵥₑ. An example of the augmented diffusion dynamics, as the Metal-ion concentration of the cathode at the current collector increases along the normalized Metal-ion concentration line 706 (e.g. from 0.7 to 0.8), the Metal-ion concentration of the anode at the current collector will correspondingly decreases along the normalized Metal-ion concentration line 708. The corresponding decrease of the anode will be a function of the increase of the cathode, but may not be equal to the amount increased in the cathode. This functional relationship allows the status or operation of one electrode (i.e. a representative electrode) to provide information to determine the status or operation of the other electrode. A change of the open circuit voltage of the anode (ΔUₙ) 726 corresponds to a change in the normalized metal-ion concentration at the surface to electrolyte interface (Δθ_{se,n}) 724.

If the metal-ion concentration of the anode is expressed by θ_{se,n}=f(θ_{se,p},SOCₐᵥₑ) to relate the metal-ion dynamics at the cathode to the metal-ion dynamics at the anode, the dynamic responses of the anode may be calculated from the dynamic response of the cathode. The terminal voltage may then be expressed as

V=Uₚ(θ_{se,p})−Uₙ(f(θ_{se,p},SOCₐᵥₑ))−R₀^{eff}I, (19)

The calculation of the energy stored in the battery (e.g. battery SoC, power capability, etc.) may require calculation of the metal-ion concentrations along the radius direction of the representative solid particle in an electrode. This can be illustrated by the equation:

SOC_{n,se}^{eff}=f₁(SOC_{p,se}^{eff},SOCₐᵥₑ)=w_{1,n}SOC_{p,se}^{eff}+w_{2,n}SOCₐᵥₑ (20)

in which

$$S O {C}_{se} = \frac{{θ}_{se} - {θ}_{0 \%}}{{θ}_{100 \%} - {θ}_{0 \%}} , {θ}_{se} = \frac{{c}_{se}}{{c}_{s , max}} and {θ}_{p , ave} = \frac{{\overline{c}}_{s}}{{c}_{s , max}}$$

for each respective electrode, the weight w₁=(SOCₐᵥₑ)^{m} in which m may be an exponent to tune the response and the weight w₂=1−w₁.

θₛₑ=θ_{0%}+SOCₛₑ(θ_{100%}−θ_{0%}) (21)

By combining eqns. (20) and (21), eqn. (19) is derived.

FIG. 8 is a graphical illustration of the battery state of charge (SOC) 804 in relation to time 802. This graphical illustration shows the average battery state of charge 806, the battery state of charge at the solid to electrolyte interface of the cathode 808 and the battery state of charge at the solid to electrolyte interface of the anode 810. A computed electrochemical dynamic from the model at one electrode 814, for example the cathode, allows predicted electrochemical dynamics of the other electrode 812, based on equations (19), (20), and (21).

Using equations (19), (20), and (21), different electrochemical dynamics between electrodes are captured, and the difference results in ΔSOC_{se,n} along the line A-A′ 816. In other words, the dynamics difference between the electrodes and resulting the difference in battery state of charge (ΔSoC_{se,n}) 818 are captured by the proposed methodology. The difference of the normalized Li-ion concentration at the negative electrode can be computed from ΔSOC_{se,n} 818, and the difference results in ΔUₙ in 726. Thus, the terminal voltage in equation (19) is computed.

The aforementioned model reduction procedure enables significant reduction of model size, but the model size may not be compact enough to implement in a battery management system. Further model reduction may be possible by reducing the number of discretization using uneven discretization. The objectives of uneven discretization are to achieve a compact model structure, and to maintain the model accuracy. Thus, the uneven discretization may produce a more compact battery model form and lower the required processor bandwidth. Other model reduction approaches could capture similar battery dynamics. However, the uneven discretization can maintain physically meaningful states to represent Metal-ion diffusion dynamics.

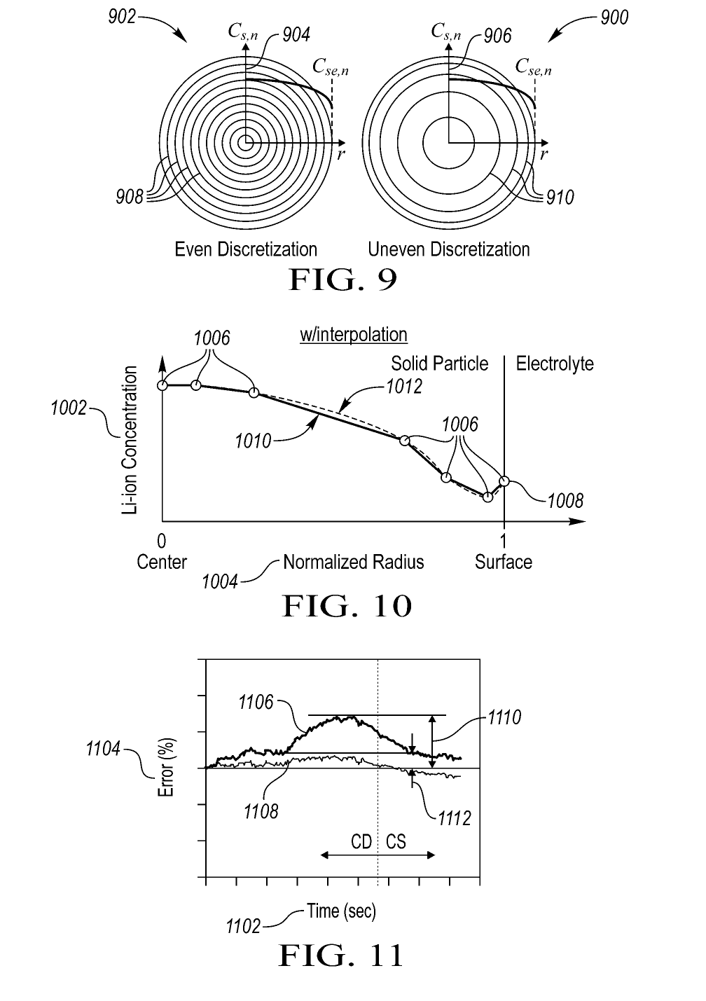

FIG. 9 shows the two different discretization approaches: uneven discretization 900, and even discretization 902. The metal-ion concentration 904 is shown on the y-axis and the active material solid particle radius 906 is shown on the x-axis. Due to the change in the metal-ion concentration as the radius increases and to meet the accuracy requirements, the use of an evenly distributed discretization method may require many calculations at multiple discrete radii 908 as shown in 902. This increases the computational need and may be cost and performance prohibitive. A solution would be to use uneven steps as shown in 900. Here, the number of steps and distance between steps may be determined by calibration, modeling or using a mathematical function of the radius. An example is shown in 900 with the steps being illustrated by 910.

Equation (14) is expressed as a set of ordinary differential equations (ODE) by using the finite difference method for the spatial variable r in order to be used as the battery control oriented model. The derived state-space equations using uneven discretization are

$$\begin{matrix}{\dot{c}}_{s}^{eff} = A {c}_{s}^{eff} + Bu , & ( 22 ) \\ A = [ \begin{matrix}- \frac{2 {D}_{s}^{eff}}{{r}_{1}^{2}} & \frac{2 {D}_{s}^{eff}}{{r}_{1}^{2}} & … & 0 & 0 \\ 0 & ⋱ & & & 0 \\ ⋮ & {α}_{j} ( \frac{1}{Δ {r}_{j - 1}} - \frac{1}{{r}_{j}} ) & - {α}_{j} ( \frac{1}{Δ {r}_{j}} + \frac{1}{Δ {r}_{j - 1}} ) & {α}_{j} ( \frac{1}{Δ {r}_{j}} + \frac{1}{{r}_{j}} ) & ⋮ \\ 0 & & & ⋱ & 0 \\ 0 & 0 & … & {α}_{Mr - 1} ( \frac{1}{Δ {r}_{Mr - 2}} - \frac{1}{{r}_{Mr - 1}} ) & - {α}_{Mr - 1} ( \frac{1}{Δ {r}_{Mr - 2}} - \frac{1}{{r}_{Mr - 1}} )\end{matrix} ] , & ( 22 a ) \\ B = {[ \begin{matrix}0 & … & 0 & - {α}_{Mr - 1} ( 1 + \frac{Δ {r}_{Mr - 1}}{{r}_{Mr - 1}} ) \frac{1}{{δ}_{p} {AFa}_{s} {D}_{s}^{eff}}\end{matrix} ]}^{T} , & ( 22 b )\end{matrix}$$

in which

$${α}_{k} = \frac{2 {D}_{s}^{eff}}{Δ {r}_{k - 1} + Δ {r}_{k}} .$$

The number of discretization points or steps is determined to obtain sufficient battery dynamics prediction accuracy. The number may be down to five while capturing the aggressive battery operations in electrified vehicle applications.

Solving equation 18 by using equations (22), (22a) and (22b) may require extensive computational power. As discussed above, the computational requirements can be reduced by the use of uneven discretization. To further improve the accuracy of this reduced order model, the use of interpolation may be used. This includes but is not limited to linear interpolation, polynomial, spline or other form of interpolation.

FIG. 10 is a graphical representation of a Metal-ion concentration (shown here as Li-ion) 1002 in relation to the normalized radius 1004 as determined by uneven discretization of the sampling steps 1006. The original profile 1010 provides adequate accuracy with the ability to reduce the computation such that it may be implemented in a current control system. In this example, unevenly distributed discretization points 1006 are shown and a linear connection between each point 1010 allows an accurate representation of the concentration along the radius, however to increase the accuracy, the points may be interpolated as shown in 1012.

The use of interpolating the profile 1012 increases the accuracy with only a small computational increase and thus may also be implemented in a current control system. The offset of the estimated SOC from the real value in the unevenly discretized reduced-order model is caused by the loss of continuous Li-ion profile information, and the lost information may be recovered by interpolation. Thus, the SOC estimation accuracy may be recovered close to the real value.

An example of an equation used to calculate the average Li-ion concentration is

$${\overline{c}}_{s} = \frac{{c}_{s , 1} {r}_{1}^{3} + {\sum }_{i = 1}^{Mr - 1} \frac{3}{8} ( {c}_{s , i} + {c}_{s , i + 1} ) {( {r}_{i} + {r}_{i + 1} )}^{2} ( {r}_{i} - {r}_{i + 1} )}{{r}_{Mr - 1}^{3}} , . \qquad ( 23 )$$

although other expressions may be used where rᵢ is the radius of the i^{th} point in the interpolated Li-ion profile curve. This interpolated concentration profile may be used to estimate the battery State of Charge (SOC) using the Li-ion concentration c_{s,i}, which is an interpolated value based on the estimated Li-ion concentration using an uneven discretized model. The battery SOC is expressed using the following equation

$$S \hat{O} C = \frac{{\overline{θ}}_{s} - {θ}_{0 \%}}{{θ}_{100 \%} - {θ}_{0 \%}} , \qquad ( 24 )$$

in which

$${\overline{θ}}_{s} = \frac{{\overline{c}}_{s}}{{c}_{s , max}} ,$$

θ_{0%} is the normalized Metal-ion concentration when the battery SOC is at 0%, θ_{100%} is the normalized Metal-ion concentration when the battery SOC is at 100% and c_{s,max} is the maximum Metal-ion concentration. This method may provide better accuracy over previous solutions (e.g. current integration, SOC estimation based on the terminal voltage using pre-calibrated maps, equivalent circuit battery models based SOC, etc.)

The battery SOC estimation accuracy may be significantly improved by the proposed Li-ion profile interpolation. FIG. 11 shows the comparison between the battery SOC estimation with interpolation 1108 and the battery SOC estimation without interpolation 1106 with a maximum battery SOC error 1110. The offset of the estimated SOC from the real value in the unevenly discretized reduced-order model is caused by the loss of continuous Li-ion profile information, and the lost information may be recovered by interpolation. Thus, the SOC estimation accuracy may be recovered close to the real value. The use of interpolation provides a battery SOC error with interpolation 1108 with a maximum battery SOC error with interpolation being 1112.

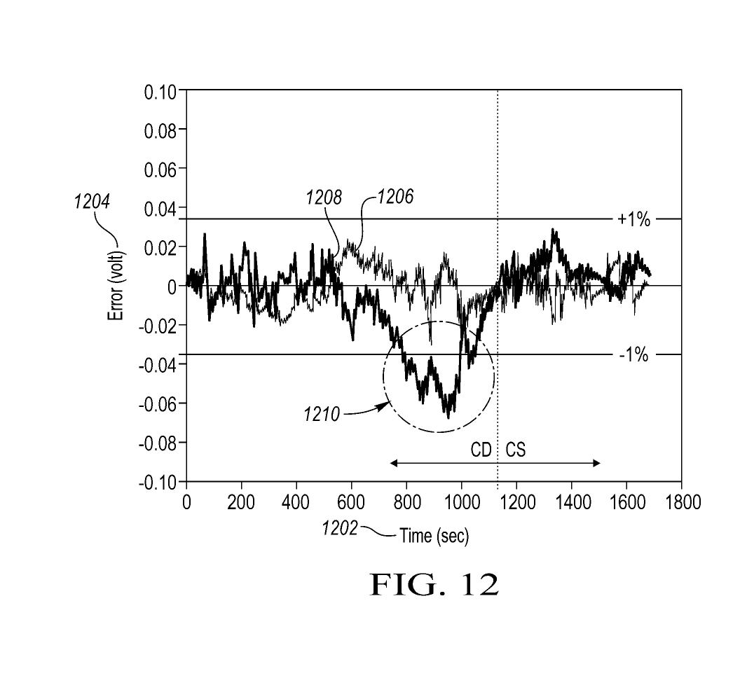

The proposed model structure is validated using vehicle test data under real-world driving. A battery current profile (not shown) and a battery terminal voltage profile (not shown) are used to generate FIG. 12. FIG. 12 is the graphical representation of the terminal voltage prediction errors 1204 in relation to time 1202 determined in a real-world driving scenario consisting of charge depleting (CD) driving and charge sustaining (CS). This data is based on the reduced-order electrochemical battery models 1206, and equivalent circuit models (ECM) 1208. During the CD to CS transition period, ECM 1208 based prediction shows higher prediction error due to the limited capability of the ECM. Specifically, the error identified at 1210 is primarily due to the inability of the ECM to capture the slow dynamic responses. In other words, the ECM may not cover the wide ranges of frequency with a limited number of RC circuits. Complicated dynamics during the CD to CS transition period may not be properly captured and may result in larger offset during the transition period as shown in FIG. 12. In contrast, the terminal voltage prediction error in the reduced-order electrochemical model is less than +1% and greater than −1% over the entire driving period regardless of driving modes and mode changes.

The structure of the model parameters Dₛ^{eff} and R₀^{eff} may be identified as a function of temperature. The temperature dependent diffusion coefficient and temperature dependent Ohmic resistance increase the accuracy of the calculation. Electrical conductivity is a strong function of temperature, other dynamics such as charge transfer dynamics and diffusion dynamics, are also affected by temperature and may be expressed as temperature dependent parameters and variables. An expression of the effective Ohmic resistance as a function of temperature may be shown as a polynomial expression

$$\begin{matrix}{R}_{0}^{eff} = {r}_{0} + {r}_{1} ( \frac{1}{T} ) + {{r}_{2} ( \frac{1}{T} )}^{2} + … + {{r}_{n} ( \frac{1}{T} )}^{n} , & ( 25 ) \\ {R}_{0}^{eff} = {\sum }_{k = 0}^{n} {{r}_{k} ( 1 / T )}^{k} , & ( 26 )\end{matrix}$$

in which rₖ is the coefficient of the polynomial. The model structure is not limited to the polynomial form, and other regression models could be used. Equations (25) and (26) may be modified to compensate for model uncertainty by multiplying R₀^{eff} by a correction coefficient k₂ as expressed below

\hat{R}₀^{eff}=k₂R₀^{eff}. (27)

The effective diffusion coefficient is modeled in a form of the Arrhenius expression.

$${D}_{s}^{eff} = {b}_{0} + {b}_{1} {e}^{- \frac{{E}_{a}}{R ( T - {b}_{2} )}} , \qquad ( 28 )$$

in which b₀, b₁, and b₂ are the model parameters determined from the identified effective diffusion coefficients at different temperature. Equation (28) may be modified to compensate for model uncertainty by multiplying Dₛ^{eff} by a correction coefficient k₁ as expressed below

$${\hat{D}}_{s}^{eff} = {k}_{1} {D}_{s}^{eff} = {k}_{1} ( {b}_{0} + {b}_{1} {e}^{- \frac{{E}_{a}}{R ( T - {b}_{2} )}} ) \qquad ( 29 )$$

Other model structures could be used, but the proposed model structures enables accurate prediction of battery dynamics responses over the wide ranges of temperature.

An output, y, of the system may be the terminal voltage and may be expressed as:

y=Hcₛ^{eff}+Du (30)

where H may be derived from a linearization of equation (18) at an operating point. The output matrix, H, may be derived from:

$${H = \frac{\partial ( {U}_{p} ( {θ}_{se , p} ) - {U}_{n} ( {θ}_{se , n} ) )}{\partial {c}_{s}^{eff}} \vert}_{{c}_{s , ref}^{eff}} \qquad ( 31 )$$

The H matrix expression may be determined based on the formulations of Uₚ and Uₙ with respect to the effective Li-ion concentration cₛ^{eff} as described in relation to FIG. 7. For determining battery power limits, the Li-ion concentration profile of the representative electrodes may be of interest. The Li-ion concentration profile may describe the state of the battery cell. The state of the battery cell may determine the battery power capability during a predetermined time period (e.g., 1 second, 10 seconds, or any arbitrary time period).

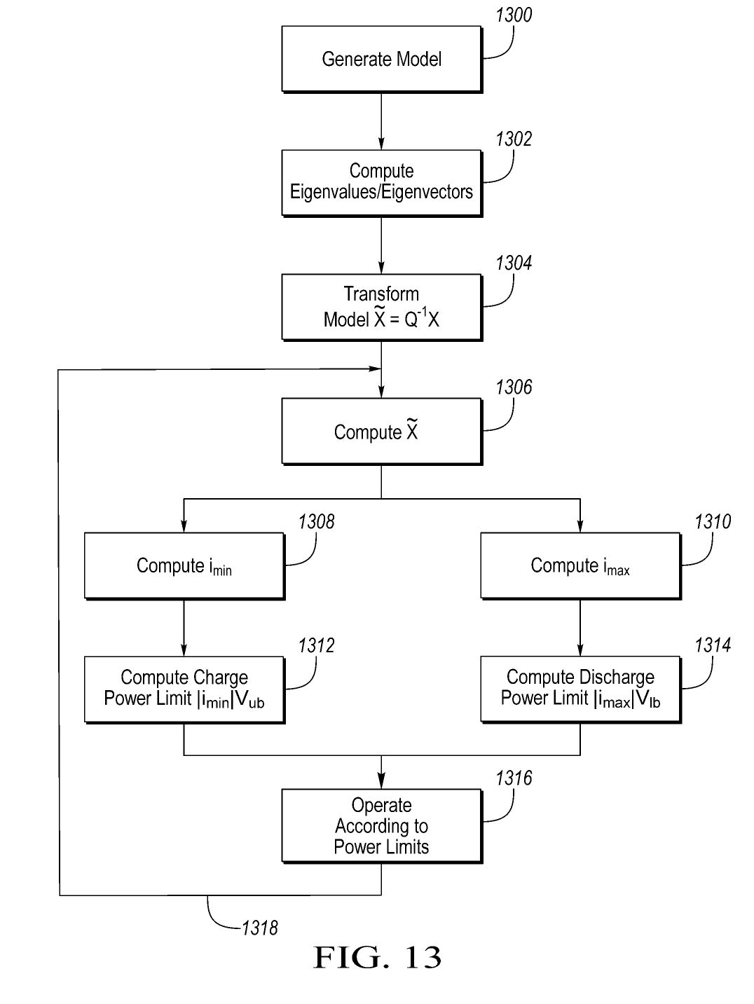

A flowchart for determining battery power limits is shown in FIG. 13. The processes may be implemented in one or more controllers. The controller may be programmed with instructions to implement the operations described herein. Operation 1300 may be implemented to generate the model as described herein. The model may utilize even or uneven discretization.

A state-space system defined by the equations (21) and (30) may be transformed into a state-space model having orthogonal coordinates by an eigendecomposition process. The transformed state-space model may enable the derivation of explicit expression of battery power capability prediction for a predetermined time period.

The system matrix, A, includes coefficients and model parameters that define the system dynamics inherent from the battery structure and chemistry. The system matrix coefficients indicate the contribution of each of the concentrations to the gradients of the concentrations. The state vector in equations (21) and (30) is the Li-ion concentration profile in a representative electrode solid particle. Each state variable in the state vector is related to the other state variables through the coefficients of the system matrix. Prediction of the state vector over a predetermined time period may require explicit integration which may be computationally expensive in an embedded controller.

The eigendecomposition of the state-space model transforms the system such that the transformed state variables are independent of one another. The dynamics of each state variable of the transformed model may be expressed independently of the other state variables. The prediction of the system dynamics may be expressed by a linear combination of the predicted state variable dynamics. Explicit expressions for battery power capability during a predetermined time period may be derived from the transformed system matrix.

Via the eigendecomposition process, the system matrix, A, may be represented as QAQ⁻¹, where Q is an n-by-n matrix whose i^{th} column is a basis eigenvector qᵢ and Λ is a diagonal matrix whose diagonal elements are corresponding eigenvalues. Operation 1302 may be implemented to compute the eigenvalues and eigenvectors of the system matrix.

Defining a transformed state vector as \tilde{x}=Q⁻¹x, a transformed model may be expressed as:

{tilde over (\dot{x}=Ã\tilde{x}+\tilde{B}u (32)

y=\tilde{C}\tilde{x}+\tilde{D}u (33)

where the transformed state-space system matrices are expressed as:

Ã=Λ (34)

\tilde{B}=Q⁻¹B (35)

\tilde{C}=HQ (36)

\tilde{D}=D (37)

The transformed battery model may be further simplified and expressed as:

{tilde over (\dot{x}=−λᵢ\tilde{x}ᵢ+\tilde{B}_{i,1}u (38)

y=Σᵢ\tilde{C}_{1,i}\tilde{x}ᵢ+\tilde{D}u (39)

where λᵢ is the eigenvalue at the i^{th} row and i^{th} column of the diagonal matrix, Λ, and \tilde{x}ᵢ is the i^{th} state variable in \tilde{x}. The output, y, corresponds to terminal voltage and the input, u, corresponds to the battery current. Each transformed state is a function of the corresponding eigenvalue and the corresponding element of the transformed input matrix. The output is a function of the transformed state and the transformed output matrix. The eigenvalues of the original system matrix are the same as the eigenvalues for the transformed system matrix. After transformation by the transformation matrix, the state variables are independent of one another. That is, the gradient for the state variables is independent of the other state variables.

Operation 1304 may be implemented to transform the original model into the diagonalized form. The transformed states are based on the effective Li-ion concentrations that make up the original state vector. Note that operations 1300 through 1304 may be performed off-line at system design time. Operation 1306 may be implemented to compute the transformed state given by equation (38).

The battery current limit for the predetermined time period may be calculated as the magnitude of the battery current that causes the battery terminal voltage to reach the battery voltage limits. The battery voltage limits may have an upper limit value for charging and a lower limit value for discharging. The battery terminal voltage with a constant battery current input over a predetermined time period may be computed by letting the battery current input be a constant value during a predetermined time period, t_{d}. By solving equations (38) and (39) with the constant current, i, and the predetermined time period, t_{d}, the battery terminal voltage, vₜ, may be expressed as:

$${v}_{t} = {v}_{OC} - {\sum }_{i}^{n} {\tilde{C}}_{1 , i} {\tilde{x}}_{i , 0} {e}^{- {λ}_{i} {t}_{d}} - ( {R}_{0} - {\sum }_{i}^{n} {\tilde{C}}_{1 , i} ( 1 - {e}^{- {λ}_{i} {t}_{d}} ) \frac{{\tilde{B}}_{i , 1}}{{λ}_{i}} ) i \qquad ( 40 )$$

The battery current limit for the time period, t_{d}, may be computed by setting vₜ to vₗᵢₘ in equation (40) to obtain:

$$i = \frac{{v}_{OC} - {v}_{lim} - {\sum }_{i}^{n} {\tilde{C}}_{1 , i} {\tilde{x}}_{i , 0} {e}^{- {λ}_{i} {t}_{d}}}{{R}_{0} - {\sum }_{i}^{n} {\tilde{C}}_{1 , i} ( 1 - {e}^{- {λ}_{i} {t}_{d}} ) \frac{{\tilde{B}}_{i , 1}}{{λ}_{i}}} \qquad ( 41 )$$

where vₗᵢₘ, corresponds to a terminal voltage limit that may represent an upper voltage bound for charging or a lower voltage bound for discharging. The variable v_{oc} represents the open-circuit voltage of the cell at a given battery SOC. The quantity \tilde{x}_{i,0} is an initial value of the transformed state variable at the present time. The initial value may be a function of the Li-ion concentrations. Rₒ is the effective internal battery resistance. The time, t_{d}, may be a predetermined time period for the battery current limit computation.

Operation 1308 may be implemented to compute a minimum battery current limit based on an upper bound voltage for vₗᵢₘ. Operation 1310 may be implemented to compute a maximum battery current limit based on a lower bound voltage for vₗᵢₘ.

The behavior of the numerator is such that for large time horizons, t_{d}>>0, the numerator summation term becomes small. The behavior of the denominator is such that for a large time horizon, the denominator summation term becomes a function of the eigenvalues and the transformed input and output matrices. For a small time horizon, the denominator summation term becomes zero so that only the effective resistance term remains.

Charge and discharge power limits may be computed as follows:

$$\begin{matrix}{P}_{lim , charge} = \vert {i}_{min} \vert {v}_{ub} = \vert \frac{{v}_{oc} - {v}_{ub} - {\sum }_{i}^{n} {\tilde{C}}_{1 , i} {\tilde{x}}_{i , 0} {e}^{- {λ}_{i} {t}_{d}}}{{R}_{0} - {\sum }_{i}^{n} {\tilde{C}}_{1 , i} ( 1 - {e}^{- {λ}_{i} {t}_{d}} ) \frac{{\tilde{B}}_{i , 1}}{{λ}_{i}}} \vert {v}_{ub} & ( 42 ) \\ {P}_{lim , discharge} = \vert {i}_{max} \vert {v}_{l b} = \vert \frac{{v}_{oc} - {v}_{l b} - {\sum }_{i}^{n} {\tilde{C}}_{1 , i} {\tilde{x}}_{i , 0} {e}^{- {λ}_{i} {t}_{d}}}{{R}_{0} - {\sum }_{i}^{n} {\tilde{C}}_{1 , i} ( 1 - {e}^{- {λ}_{i} {t}_{d}} ) \frac{{\tilde{B}}_{i , 1}}{{λ}_{i}}} \vert {v}_{l b} & ( 43 )\end{matrix}$$

where iₘᵢₙ is calculated with vₗᵢₘ set to v_{ub}, and iₘₐₓ is calculated with vₗᵢₘ set to v_{lb}. The voltage limit v_{ub} is a maximum terminal voltage limit of the battery and the voltage limit v_{lb} is a minimum terminal voltage limit of the battery. The upper and lower terminal voltage limits may be predetermined values defined by the battery manufacturer.

Operation 1312 may be implemented to compute the charge power limit during the predetermined time period, and operation 1314 may be implemented to compute the discharge power limit during the predetermined time period. Operation 1316 may be implemented to operate the battery according to the power limits. In addition, components connected to the battery may be operated within the battery power limits. For example, an electric machine may be operated to draw or supply power within the battery power limits. Path 1318 may be followed to repeat the process of computing the real-time battery power capability. The model parameters and coefficients of the system, input, and output matrices may be derived off-line during development of the model. The eigenvalues and corresponding eigenvectors may be computed using existing mathematical programs and algorithms. Coefficients of the transformed system, input and output matrices may be generated off-line as well.

Prior art methods of battery power limit calculation rely on an electrical model (see FIG. 3) for calculating the battery power limits. In contrast, battery power limits may be calculated based on the reduced-order electrochemical battery model as disclosed herein.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a fraction battery including cells each having an anode, a cathode and an electrolyte therebetween; and
at least one controller programmed to operate the traction battery based on at least one temperature dependent electrode diffusion coefficient that increases as temperature increases, a temperature dependent Ohmic resistance that decreases as temperature increases, and an operating battery current.

2. The vehicle of claim 1, wherein the temperature dependent electrode diffusion coefficient includes a temperature dependent anode diffusion coefficient or a temperature dependent cathode diffusion coefficient.

3. The vehicle of claim 1, wherein the temperature dependent Ohmic resistance includes a temperature dependent anode Ohmic resistance or a temperature dependent cathode Ohmic resistance.

4. The vehicle of claim 3, wherein the at least one controller is further programmed to operate the traction battery based on a battery terminal voltage, a battery power capability or a battery state of charge.

5. The vehicle of claim 4, wherein the battery terminal voltage is based on a temperature dependent normalized cathode metal-ion concentration at a cathode-electrolyte interface, or a temperature dependent normalized anode metal-ion concentration at a anode-electrolyte interface.

6. The vehicle of claim 4, wherein the battery state of charge is based on a temperature dependent normalized cathode metal-ion concentration within the cathode and at a cathode-electrolyte interface, or a temperature dependent normalized anode metal-ion concentration within the anode and at a anode-electrolyte interface.

7. The vehicle of claim 4, wherein the battery state of charge is expressed as a power associated with the state of charge.

8. The vehicle of claim 1, wherein the at least one controller is further programmed to operate the traction battery based on a normalized Li-ion concentration at a solid electrolyte interface of a representative electrode solid particle, and a function of the normalized Li-ion concentration at the solid electrolyte interface of the representative electrode solid particle and a battery state of charge.

9. The vehicle of claim 1, wherein the at least one controller is further programmed to operate the traction battery based on a normalized Li-ion concentration at a solid electrolyte interface of a representative electrode solid particle, and a function of a weighted average of the normalized Li-ion concentration at the solid electrolyte interface of the representative electrode solid particle and a battery state of charge.

10. The vehicle of claim 9, wherein the weights are determined as a function of the battery state of charge.

11. The vehicle of claim 1, wherein the cells are Li-ion cells.

12. A method of operating a traction battery having cells with electrodes comprising:
outputting a temperature dependent Ohmic resistance based on a diffusion overpotential rate of change and an electrolyte electrical potential rate of change associated with a battery current;
outputting a temperature dependent diffusion coefficient based on a frequency response, at frequencies less than a predetermined frequency, of the battery to a change in the battery current;
outputting a battery operational variable based on a battery model including the temperature dependent diffusion coefficient and temperature dependent Ohmic resistance; and
operating the traction battery, by a controller, based on the battery operational variable, a battery temperature, the battery current and a battery current demand.

13. The method of claim 12, wherein the battery model is a state-space equation.

14. The method of claim 12, wherein the temperature dependent diffusion coefficient is based on a function of an Arrhenius equation.

15. The method of claim 12, wherein operating the traction battery is further based on one of a number of charge-discharge cycles, an age of the battery, and historical battery decay over time.

16. The method of claim 12, wherein the temperature dependent diffusion coefficient includes an anode temperature dependent diffusion coefficient and a cathode temperature dependent diffusion coefficient.

17. A vehicle battery system comprising:
a traction battery including at least one cell having an anode, a cathode and an electrolyte therebetween defining a solid-electrolyte interface including an anode solid-electrolyte interface and a cathode solid-electrolyte interface; and
at least one controller programmed to operate the traction battery according to a battery operational variable that is based on a temperature dependent diffusion coefficient of the solid-electrolyte interface, a temperature dependent Ohmic resistance, a Li-ion concentration that is derived from a response to a current profile, and an operating battery current.

18. The system of claim 17, wherein the battery operational variable is based on a normalized Li-ion concentration at the solid-electrolyte interface of a representative electrode solid particle, and a function of the normalized Li-ion concentration at the solid-electrolyte interface of the representative electrode solid particle and an average, taken over a predetermined time, of a plurality of historical battery state of charge.

19. The system of claim 17, wherein the battery operational variable is based on a normalized Li-ion concentration at a solid-electrolyte interface of a representative electrode solid particle, and a function of a weighted average of the normalized Li-ion concentration at the solid-electrolyte interface of the representative electrode solid particle and an average, taken over a predetermined time, of a plurality of historical battery states of charge.

20. The system of claim 17, wherein the temperature dependent diffusion coefficient increases as temperature increases and the temperature dependent Ohmic resistance decreases as temperature increases.
